(19) United States
(12) Patent Application Publication
(10) Pub. No.: US 2013/0323614 A1
(43) Pub. Date: Dec. 5, 2013

(54) GAS STREAM PRODUCTION

(71) Applicants: Chris Chapman, Oxfordshire (GB); Rolf Stein, Surrey (GB); Martin Brooks, Hertfordshire (GB); Edward S. Manukian, Falls Church, VA (US); Robert M. Clark, Irwin, PA (US)

(72) Inventors: Chris Chapman, Oxfordshire (GB); Rolf Stein, Surrey (GB); Martin Brooks, Hertfordshire (GB); Edward S. Manukian, Falls Church, VA (US); Robert M. Clark, Irwin, PA (US)

(73) Assignee: ADVANCED PLASMA POWER LIMITED, Swindon (GB)

(21) Appl. No.: 13/978,570

(22) PCT Filed: Jan. 6, 2012
(86) PCT No.: PCT/GB2012/050020

§ 371 Date: Aug. 19, 2013

Related U.S. Application Data
(60) Provisional application No. 61/430,574, filed on Jan. 7, 2011.

(30) Foreign Application Priority Data
Apr. 7, 2011 (GB) 1105962.3

(51) Int. Cl. C01B 3/02; H01M 8/06; B01J 7/00; E21B 43/16; C01B 31/20

(52) U.S. Cl. CPC C01B 3/02; E21B 43/164; C01B 31/20; B01J 7/00; H01M 8/0612
USPC 429/420; 166/268; 166/90.1; 423/650; 423/437.2; 422/611; 422/139

(57) ABSTRACT

Gas Stream Production The present invention provides a method for the production of carbon dioxide and/or hydrogen gas streams, the method comprising: (i) thermally treating a feedstock material to produce a syngas comprising carbon monoxide and hydrogen and plasma-treating the syngas in a plasma treatment unit; (ii) reacting the plasma-treated syngas with water in a further treatment unit, whereby at least some of the carbon monoxide is converted into carbon dioxide; and (iii) recovering hydrogen and/or, separately, carbon dioxide from the syngas.

The present invention relates to the production of gas streams from feedstock materials and the practical application of those gas streams. In particular, the present invention relies upon the plasma treatment of a syngas produced from a feedstock to produce carbon dioxide and/or hydrogen gas streams. These streams can be advantageously used for purposes such as oil/gas recovery or energy generation.

EP1896774, incorporated herein by reference, discloses the treatment of municipal waste in a two step process. Firstly, the waste is gasified in a gasification unit. Gasification, while being moderately successful in processing the majority of waste, nevertheless produces a gas that contains uncombusted particulates, low volatility tarry species, airborne compounds and a solid non-airborne char.

The gas that results from the gasification of waste (termed an ‘offgas’) can be used in a gas turbine or gas engine, but the airborne particulates and tarry hydrocarbon molecules have a tendency to clog the turbine or engine. EP1896774 therefore discloses a plasma treatment of the off-gas and the solid non-airborne char in a plasma treatment unit. This extracts any remaining organic species from the char, which it then vitrifies, and cracks any airborne organic species into carbon monoxide and hydrogen for use in a gas turbine or gas engine.

Gas turbines and gas engines are sensitive to the homogeneity of the syngas feedstock. Accordingly, the process disclosed in EP1896774 may be used to treat homogenised organic waste of constant calorific value (CV). Indeed, the process disclosed in EP1896774 can be optimised for the treatment of Refuse Derived Fuel (RDF) and Solid Recovered Fuel (SRF).

Accordingly, there is a desire for a process that will overcome, or at least mitigate, some or all of the problems associated with the methods of the prior art or at least a useful or optimised alternative.

According to a first aspect, the present invention provides a method for the production of carbon dioxide and/or hydrogen gas streams, the method comprising:
(i) thermally treating a feedstock material to produce a syngas comprising carbon monoxide and hydrogen and plasma-treating the syngas in a plasma treatment unit;
(ii) reacting the plasma-treated syngas with water in a further treatment unit, whereby at least some of the carbon monoxide is converted into carbon dioxide; and
(iii) recovering hydrogen and/or, separately, carbon dioxide from the syngas.

The present disclosure will now be further described. In the following passages different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Preferably the feedstock material is thermally treated by gasifying the feedstock material to produce the syngas. Preferably the feedstock is gasified in a separate treatment unit from the plasma treatment unit.

The method of the present invention has been found to be surprisingly energy efficient. It has also been found that in particular the combination of the gasification treatment and plasma treatment of a feedstock provides a high purity source of carbon dioxide and/or hydrogen gas that is particularly suited for use in combination with enhanced oil recovery techniques (EOR) and hydrogen fuel cell technology. Advantageously, the process can be used to treat a waste feedstock and thereby derive energy from a waste product.

In step (i) the feedstock is thermally treated, preferably by gasification. Gasification is the partial combustion of a material, where the oxygen in the gasification unit is controlled such that it is present at a sub-stoichiometric amount, relative to the material. Gasification of feedstock containing carbonaceous components results in a combustible fuel gas, or syngas, rich in carbon monoxide, hydrogen and some saturated hydrocarbons, principally methane. The gas produced also contains some carbon dioxide and moisture. Gasification and gasification units suitable for use in the present invention are disclosed in EP1896774, incorporated herein by reference.

Preferably the feedstock is gasified in step (i) in the presence of presence of oxygen and steam.

In one embodiment, the thermal treatment may be performed in the plasma treatment step. That is, the plasma treatment unit can be used to thermally treat the feedstock to produce the syngas and then to plasma treat the syngas in a single step. Alternatively, two separate plasma treatment steps may be carried out, a first to produce a syngas and a second to plasma treat the syngas. These embodiments are less preferred since the use of a plasma treatment to gasify a waste has been found to have a low efficiency.

The syngas is plasma treated in a plasma treatment unit. This serves to crack any hydrocarbons present in the syngas and increase the amounts of hydrogen and carbon monoxide present in the syngas. The plasma treatment is carried out under controlled conditions to ensure that carbon dioxide production is reduced and the hydrogen is not converted to water. Preferably the plasma treatment is carried out in the presence of water.

The present inventors have discovered that the plasma treatment of the syngas allows for the production of a refined syngas product that is very low in hydrocarbons, including tarry species. Moreover, the inventors have found that if tars are not removed prior to the water gas shift (WGS) reaction stage, then they are liable to deposit on the surface of the catalysts which will severely reduce the activity of the catalyst over time. Thus, the use of a plasma treatment unit in combination with a WGS reactor allows for high levels of conversion efficiency to be maintained.

A further advantage of the plasma treatment lies in the conversion of hydrocarbons in the syngas. These hydrocarbons are able to pass through the WGS reaction stage without being converted: this represents a loss in energy efficiency and overall carbon/hydrogen yield. The plasma converter is highly efficacious in breaking down these problematic hydrocarbon species and, therefore, the plasma treatment leads to maximised energy yields from the feedstock.

In step (ii) at least some of the plasma treated syngas is reacted with water in a further treatment unit. Preferably all of the syngas is contacted with water. Preferably the water is present in the form of steam. Under these conditions a water-gas shift reaction occurs in which carbon monoxide reacts with water vapour to form carbon dioxide and hydrogen:

CO(g)+H₂O(v)→CO₂(g)+H₂(g)

Thus, the amount of carbon dioxide and hydrogen present in the stream increases. The reaction is exothermic and is carried out in the further treatment unit at a lower temperature than the plasma treatment to favour the forward reaction. Preferably in step (iii) the syngas is contacted with sufficient water to convert substantially all of the carbon monoxide into carbon dioxide and water.

This reaction may be catalysed with iron oxide and/or chromium oxide and/or copper on a mixed support composed of zinc oxide and aluminium oxide. Other catalysts may include Fe₃O₄ (magnetite), or other transition metals and transition metal oxides, or Raney copper catalyst.

Syngas generated from the thermal treatment process (ignoring H₂O content, which is preferably minimised) may contain approximately 39 mol % H₂. The remaining components are approximately 38 mol % CO and approximately 15 mol % CO₂. To produce H₂ rich fuel, syngas can be treated further to reduce its CO and CO₂ concentration.

The water-gas shift (WGS) reaction, Equation 1, is a method for converting carbon monoxide to carbon dioxide and hydrogen. The inventors have realised that this method can be used for further enhancing the yield of hydrogen as well as reducing the CO concentration in the syngas. Water, preferably steam, is added to the syngas mixtures containing mostly hydrogen and carbon monoxide prior to being introduced to WGS reactors to convert the CO to CO₂ and additional H₂.

CO+H₂O→CO₂+H₂ ΔH=−41 kJ/mol (1)

WGS is a reversible, exothermic reaction that is thermodynamically unfavourable at elevated temperatures. There are two preferred types of WGS catalysts which are used. One is a high temperature shift (HTS) catalyst, which consists of oxides of iron and chromium and is used at 300-500° C. to reduce the carbon monoxide to around 2-5%. The second one is a low temperature shift catalyst (LTS) composed of copper, zinc oxide and alumina used between 200-250° C. to r educe the CO concentration to ˜1%.

At the high temperatures the conversion is equilibrium limited and at low temperatures it is kinetically limited. In order to maximize CO conversion and H₂ production, a combination of the two catalysts is used. Around 90-95% CO conversion can be achieved by WGS reaction. During the production of hydrogen, CO₂ is also produced. CO₂ in the treated gas needs to be captured and removed to produce a H₂ rich gas.

In step (iii) the syngas following the water gas shift reaction is processed so as to recover at least one of carbon dioxide and hydrogen and preferably both. Preferably the carbon dioxide is recovered from the syngas by amine separation. The purity of the carbon dioxide recovered is preferably at least 98%.

Preferably the hydrogen is recovered from the syngas by a pressure swing absorption process. The purity of the hydrogen recovered is preferably at least 90%. Other techniques are known in the art and are suitable for hydrogen recovery.

For CO₂ removal, selection of the process can be based on gas composition and operating conditions. High CO₂ partial pressure in the feed gas enhances the possibilities of employing physical solvent, while the presence of significant amount of heavy hydrocarbon discourages the use of physical solvent. Low CO₂ partial pressures and low outlet pressure of the product stream favour application of chemical solvents.

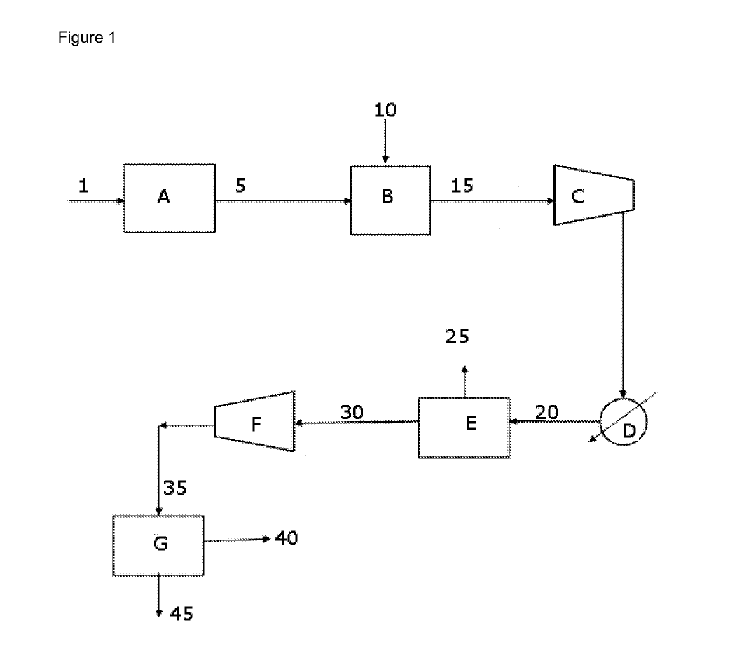

The partial pressure of CO₂ coming out from WGS reactor (FIG. 1) is quite low (around 5.7 psi). Hence, the partial pressure of CO₂ in the feed gas is particularly suited for chemical absorption processing.

Preferably the CO₂ is retrieved using an alkanolamines chemical solvent. The reactivity and availability at low cost, especially of monoethanolamine (MDEA), and diethanolamone (DEA), make these solvents ideal. Chemical absorption processes are based on exothermic reaction between the solvent and the CO₂ present in the gas stream. Most chemical reactions are reversible, in this case solvent removes CO₂ in the contactor (absorber), preferably at high pressure (5-200 atm) and preferably at low temperature (35-50° C.). The reaction is then preferably reversed by endothermic stripping process at high temperature (90-120° C.) and low pressure (1.4-1.7 atm). The CO₂ recovery rates from amine-based solvent are preferably at least 95%, more preferably at least 98% and most preferably 99% or higher.

An additional process step may be used to purify the exit gas stream from amine process to get pure hydrogen. High to ultra-high purity hydrogen may be needed if it is used for fuel cells for the durable and efficient operation.

The preferred processes for hydrogen upgrading are the pressure swing adsorption (PSA) process, polymeric membrane separation process and the cryogenic separation process. Feed composition has a large impact on the selection of a hydrogen separation process. Higher hydrogen content of the feed favours the PSA and membrane processes, and lower hydrogen content favours cryogenic separation. Streams with 75-90 vol-% hydrogen are most economically upgraded by PSA or membrane processes. Streams with significant quantities of CO, CO₂, and nitrogen, such as the effluent from a stream reformer, are almost always upgraded by the PSA process, as this is the only process which can remove these components easily and completely. In particular, the removal of CO and CO₂ to 10-15 ppmv is often a requirement and this can advantageously be achieved by the PSA process in a single step.

The PSA process for hydrogen purification is based on the capacity of adsorbents to adsorb more impurities at high gas-phase partial pressure than at low partial pressure. Impurities are adsorbed in an adsorber at higher partial pressure and then desorbed at lower partial pressure. The impurity partial pressure is lowered by “swinging” the adsorber pressure from the feed pressure to the tail gas pressure, and by using a high-purity hydrogen purge. The driving force for the separation is the impurity partial pressure difference between the feed and the tail gas. Preferably a minimum pressure ratio of approximately 4:1 between the feed and tail gas pressure is used for hydrogen separation.

The absolute pressures of the feed and tail gas are also important for hydrogen recovery. The optimum feed pressure range for PSA units in refinery applications is 200-400 psig. The optimum tail gas pressure is as low as possible.

Two of the advantages of the PSA process are its ability to remove impurities to any level (e.g., ppmv levels if desired), and to produce a very high purity hydrogen product. Typical PSA hydrogen product purities range from 99 to 99.999 vol-%. Removal of CO and CO₂ to 0.1-10 ppmv levels is common and easily achieved. The hydrogen recovery achievable by PSA units is moderate, typically 80-92% at optimum conditions. The fuel energy in the tail gas can be used for heating applications elsewhere on the plant.

Preferably, after the hydrogen and/or carbon dioxide is recovered from the syngas, the remaining syngas is passed back into the plasma treatment unit. This recycling of the syngas allows for all of the hydrocarbon content to be recovered and is an efficient recycling of any residual heat in the syngas.

In one embodiment, the syngas following step (ii) is subjected to an intervening step before step (iii), whereby the syngas is cooled so that moisture present in the syngas condenses and can be removed from the gas stream. Such condensing techniques are well known in WGS treatment processes. In one embodiment, further treatment may be carried out at this point to remove undesirable impurities.

The feedstock is preferably a biomass feedstock. That is, the feedstock comprises a substantial amount of hydrogen, carbon and oxygen. Suitable biomass feedstocks include one or more of wood, waste, fossil fuels, and plant-derived matter. Preferably the feedstock is a waste material, preferably a municipal waste or a refuse derived fuel.

If municipal waste is used then it is preferred that this has been pre-treated to ensure that it has a substantially constant CV. Suitable pre-treatment methods include sorting, picking, homogenising and microbial treatment. It is most preferred that the waste stream is predominantly Refuse Derived Fuel and/or Solid Recovered Fuel. These are commercially available and well known in the art.

The feedstock may have been pre-treated to increase its homogeneity prior to thermal treatment. “Homogenous” indicates that the feedstock should have one or more properties which do not vary to a great extent throughout the bulk of the feedstock or from batch to batch, if the feedstock is fed in batches to the treatment unit; hence the value of the property in question does not vary to a great extent as the feedstock is fed to the treatment unit. Such properties that preferably do not vary to a great extent include the calorific value, the size of constituents, moisture content, ash content, and density of the material. Preferably one or more of these properties varies by 20% or less, preferably 15% or less, more preferably 10% or less. Preferably, the calorific value and the moisture content of the material being fed are relatively consistent during the process.

Various processes may be used to homogenise various properties of the feedstock material, for example: microbial digestion, picking, shredding, drying, screening, mixing and blending. Of these, microbial digestion is preferred and this process is explained in more detail below.

The consistency of the property/properties of interest may be measured by taking samples of the same weight from either (i) a given number of batches of the feedstock fed to the treatment unit over a period of time (if the feedstock is fed batch-wise to the treatment unit) or (ii) at given intervals of time if the feedstock is fed substantially continuously to the treatment unit. Sampling methods known to the skilled person may be used to measure the consistency of the feedstock. Furthermore, the consistency of the processed material may be determined by taking samples from the treatment unit, after the treatment unit and/or before or after plasma treatment.

The feedstock preferably has a moisture content of 30% or less by weight, preferably 20% or less by weight. The moisture content of the feedstock preferably varies by 10% or less, more preferably by 5% or less. The moisture content of the feedstock may be controlled using processes known to those skilled in the art, such as drying, or by using the microbial digestion processes described herein.

The method is preferably carried out as a continuous method. However, it should be appreciated that the feedstock stream may be processed in a batchwise manner.

According to a second aspect, the present invention provides a method for recovering oil and/or gas from an oil and/or gas well, the method comprising: performing the method described herein for obtaining hydrogen and/or carbon dioxide gas streams; and
(iv) introducing the recovered carbon dioxide into an oil and/or gas well, whereby oil and/or gas is displaced from the well; and
(v) recovering said oil and/or gas from the well.

These techniques require very high purity gases. The use of plasma treatment to refine the syngas from thermal treatment leads to a very high purity source of hydrogen and carbon monoxide (carbon dioxide post WGS). Accordingly, the extent to which the gas streams need to be refined is minimised and the energy cost associated with these techniques is consequentially reduced.

In one embodiment the recovery involves hydraulic fracturing (called “fracking”). This is a process that results in the creation of fractures in rocks, the goal of which is to increase the output of a well. Hydraulic fractures in the well which may be natural or man-made and are extended by internal fluid pressure which opens the fracture and causes it to extend through the rock. Natural hydraulic fractures include volcanic dikes, sills and fracturing by ice as in frost weathering. Man-made fluid-driven fractures are formed at depth in a borehole and extend into targeted formations. The fracture width may advantageously be maintained after the injection by introducing a proppant into the injected fluid. Proppant is a material, such as grains of sand, ceramic, or other particulates, that prevent the fractures from closing when the injection is stopped. Introducing the carbon dioxide into the well allows for fracking and the release of further trapped oil and/or gas.

It is important that the carbon dioxide used for fracking is of high purity for a number of reasons. These include avoiding impurities, contamination or explosion risks and for ease of recycling any carbon dioxide leaving the well back into the system. Advantageously, the treatment process provides a source of high purity carbon dioxide.

Alternatively, the recovery may involve so-called enhanced oil recovery (EOR). Advantageously the CO₂ is injected into a well to provide pressure to expel oil from the well. Advantageously, as well as providing pressure, the CO₂ can help reduce the viscosity of the crude oil as the gas mixes with it. Advantageously, the use of pure CO₂ avoids any potential fire risk. The available mechanism for oil recovery will range from oil swelling and viscosity reduction for injection of immiscible fluids (at low pressures) to completely miscible displacement in high-pressure applications. This will depend on the conditions in the well (temperature and pressure and the amount of recoverable material present in the well). In these applications, more than half and up to two-thirds of the injected CO₂ returns with the produced oil and may advantageously be re-injected into the reservoir to minimize operating costs. The remainder is trapped in the oil reservoir by various means and advantageously provides a form of CO₂ sequestration.

It is also important that the carbon dioxide used for EOR is of high purity for a number of reasons. These include avoiding impurities, contamination or explosion risks and for ease of recycling any carbon dioxide leaving the well back into the system. Advantageously, the treatment process provides a source of high purity carbon dioxide.

Preferably the method further comprises recovering heat from the syngas following step (i) to heat the carbon dioxide introduced into the oil and/or gas well.

Preferably the recovered carbon dioxide is converted into a super critical state before being introduced into the oil and/or gas well. This is aided by having a high purity carbon dioxide source. Supercritical carbon dioxide refers to carbon dioxide that is in a fluid state while also being at or above both its critical temperature and pressure. It behaves as a supercritical fluid above its critical temperature (31.1° C.) and critical pressure (72.9 atm/7.39 MPa), expanding to fill its container like a gas but with a density like that of a liquid. Supercritical carbon dioxide use increases the yields achievable in both EOR and fracking techniques.

According to a third aspect, the present invention further provides a method for producing electricity, the method comprising;
performing the steps of the method described herein for obtaining hydrogen and/or carbon dioxide gas streams, and optionally for recovering oil from a well; and
passing the recovered hydrogen into a hydrogen fuel cell and contacting said hydrogen with a source of oxygen to generate electricity.

Hydrogen fuel cells are well known in the art. Such cells advantageously provide energy with only water as the by-product and are highly efficient.

According to a fourth aspect, the present invention provides an apparatus for carrying out the method as described herein, the apparatus comprising;
(a) an optional gasification unit for the gasification of a feedstock;
(b) a plasma treatment unit, the plasma treatment unit being in fluid communication with the gasification unit if present; and
(c) an amine separation unit in fluid communication with said plasma treatment unit; and
preferably, at least one of:
   (i′) an oil and/or gas well and means for introducing carbon dioxide produced by said method into said well; and
   (ii′) a hydrogen fuel cell.

The process according to the present invention preferably comprises a gasification step. The gasification step may, for example, be carried out in a vertical fixed bed (shaft) gasifier, a horizontal fixed bed gasifier, a fluidised bed gasifier, a multiple hearth gasifier or a rotary kiln gasifier.

Preferably, the gasification step is carried out in a fluid bed gasification unit. Fluid bed gasification has been found to process the feedstock more efficiently than the other gasification processes available. The fluid bed technique permits very efficient contacting of the oxidant and feed streams leading to rapid gasification rates and close temperature control within the unit.

A typical fluid bed gasification unit may comprise a vertical steel cylinder, usually refractory lined, with a sand bed, a supporting grid plate and air injection nozzles known as tuyeres. When air is forced up through the tuyeres, the bed fluidises and expands up to twice its resting volume. Solid fuels such as coal or refused derived fuel, or in the case of the present invention, the feedstock, can be introduced, possibly by means of injection, into the reactor below or above the level of the fluidised bed. The “boiling” action of the fluidised bed promotes turbulence and transfers heat to the feedstock. In operation, auxiliary fuel (natural gas or fuel oil) is used to bring the bed up to operating temperature 550° C. to 950° C., preferably 650° C. to 850° C. After start-up, auxiliary fuel is usually not needed.

Preferably the gasification unit has an inlet for oxygen and optionally an inlet for steam and the plasma treatment unit has an inlet for oxygen and optionally an inlet for steam. “Steam” includes water in the gaseous form, vapour and water suspended in a gas as droplets. Preferably, the steam is water having a temperature of 100° C. or more. Water, which will be converted to steam, may be introduced into the gasification unit and/or plasma treatment unit in the form of liquid water, a spray of water, which may have a temperature of 100° C. or less, or as vapour having a temperature of 100° C. or more; in use, the heat in the interior of the gasification unit and/or plasma treatment unit ensures that any liquid water, which may be in the form of airborne droplets, is vaporised to steam.

Preferably the gasification unit, most preferably the fluid bed gasification unit, will be a vertical, cylindrical vessel, which is preferably lined with an appropriate refractory material, preferably comprising alumina silicate.

In a fluid bed gasification unit, the distance between the effective surface formed by the particles of the fluid bed when fluid (i.e. when gas is being fed through the particles from below) and the top of the unit is called the “free board height”. In the present invention, the free board height, in use, will preferably be 3.5-5.0 times the internal diameter of the unit. This geometric configuration of the vessel is designed to permit adequate residence time of the feedstock within the fluid bed to drive the gasification reactions to completion and also to prevent excessive carry over of particulates into the plasma unit. The gasification unit will preferably employ a heated bed of ceramic particles suspended (fluidized) within a rising column of gas. The particles may be sand-like.

Preferably, the feedstock will be fed continuously to the gasification unit at a controlled rate. If the gasification unit is a fluid bed gasification unit, preferably the feedstock is fed either directly into the bed or above the bed.

Preferably, the feedstock feed will be transferred to the gasifier unit using a screw conveyor system, which enables continuous addition of feedstock. The feedstock feed system may incorporate an air lock device, such that the feedstock can be fed into the gasification unit through the air lock device to prevent air ingress or gas egress to/from the interior of the gasifier unit. The feedstock is preferably fed through the airlock device with additional inert gas purging. Air lock devices are known to the skilled person.

During the gasification process, the gasification unit should be sealed from the surrounding environment to prevent ingress or egress of gases to/from the gasification unit, with the amount of oxygen and/or steam being introduced to the gasification unit as required in a controlled manner.

If the gasification unit is a fluid bed gasification unit, preferably oxidants comprising oxygen and steam are fed below the bed, which may be through a series of upward facing distribution nozzles.

The gasification may be carried out in the presence of steam and oxygen. As mentioned above, water, which will be converted to steam, may be introduced into the gasification unit in the form of liquid water, a spray of water, which may have a temperature of 100° C. or less, or as vapour having a temperature of 100° C. or more. In use, the heat in the interior of the gasification unit ensures that any liquid water, which may be in the form of airborne droplets, is vaporised to steam. Preferably the steam and oxygen will be closely metered to the unit and the rate of feed adjusted to ensure that the gasifier operates within an acceptable regime. The amount of oxygen and steam introduced to the gasification unit relative to the amount of feedstock will depend on a number of factors including the composition of the feed, its moisture content and calorific value. Preferably, the amount of oxygen introduced to the gasification unit during the gasification step is from 300 to 350 kg per 1000 kg of feedstock fed to the gasification unit. Preferably, the amount of steam introduced to the gasification unit is from 0 to 350 kg per 1000 kg of feedstock introduced to the gasification unit, more preferably from 300 to 350 kg per 1000 kg of feedstock if the feedstock contains less than 18% by weight moisture. If the feedstock contains 18% or more by weight moisture, preferably the amount of steam introduced to the gasification unit is from 0 to 150 kg per 1000 kg of feedstock.

The gasification unit will preferably comprise a fossil fuelled underbed preheat system, which will preferably be used to raise the temperature of the bed prior to commencement of feeding to the unit.

Preferably the gasification unit will comprise multiple pressure and temperature sensors to closely monitor the gasification operation.

Preferably the feedstock will be gasified in the gasification unit at a temperature greater than 650° C., more preferably at a temperature greater than 650° C. up to a temperature of 1000° C., most preferably at a temperature of from 800° C. to 950° C.

Fluid bed gasification systems are quite versatile and can be operated on a wide variety of fuels, including municipal waste, sludge, biomass materials, coal and numerous chemical wastes. The gasification step of the process of the present invention may comprise using a suitable bed media such as limestone (CaCO₃), or, preferably, sand. During operation, the original bed material may be consumed, and may be replaced by recycled graded ash (Char) material from the gasification stage.

Preferably, the whole process is an integrated process, in that all the steps are carried out on one site and means are provided to transport the products from each step to the next. Each step is carried out in a separate unit. In particular, the gasification and the plasma treatment are carried out in separate units, to allow the conditions in each unit to be varied independently.

The process according to the present invention comprises a plasma treatment step. The plasma treatment is preferably carried out in the presence of oxygen and/or steam, which each can act as an oxidant. Preferably, the amount of oxidant is controlled. More preferably, the amount of oxidant is controlled such that that the gaseous hydrocarbons (including low volatility, tar products), the airborne carbon particulates, carbon contained in the char and part of the carbon monoxide is converted to carbon monoxide and carbon dioxide, preferably such that the ratio of the CO/CO₂ after the plasma treatment stage is equal or greater than the gas exiting the gasifier unit. Preferably, the plasma treatment is carried out on the char until substantially all of the carbon content in the char has been converted to gas or airborne species.

As mentioned above, water, which will be converted to steam, may be introduced into plasma treatment unit in the form of liquid water, a spray of water, which may have a temperature of 100° C. or less, or as vapour having a temperature of 100° C. or more. In use, the heat in the interior of the gasification unit and/or plasma treatment unit ensures that any liquid water, which may be in the form of airborne droplets, is vaporised to steam.

Preferably, the ratio of oxygen to steam is from 10:1 to 2:5, by weight.

Preferably, the plasma treatment of the feedstock is carried out at a temperature of from 1100 to 1700° C., preferably from 1300 to 1600° C.

Preferably, the plasma treatment of the feedstock is carried out in the presence of a plasma stabilizing gas. Preferably, the plasma stabilizing gas is selected from nitrogen, argon, hydrogen, and carbon monoxide.

Preferably, water, which will be converted into steam, is introduced into the plasma treatment unit in the form of a spray of water having a temperature below 100° C. There are two main advantages of doing so: firstly, the water in the spray has the effect of cooling the syngas produced in the plasma unit due to promotion of the endothermic reaction of water with carbon (to produce hydrogen and carbon monoxide). Secondly, the overall chemical enthalpy of the produced syngas is increased, allowing a greater export of electrical power if the gas is used to generate electricity. (i.e. giving an improvement in the overall net electrical conversion efficiency). Introduction of water during gasification or plasma treatment advantageously reduces the amount of water required during the WGS reaction.

If the chemical composition and mass throughput of the reactants are generally constant, then the ratio of oxidant to the reactant streams (containing the feedstock) will also preferably be maintained at a constant value. An increase in the feed rate of the reactants will preferably lead to a proportionate increase in the oxidant addition rate, which may be controlled by automatic oxidant addition means. The electrical power supplied to the plasma will also preferably be adjusted to match the change in the feed rate of the feedstock to the plasma unit and will take account of the thermo-chemistry of the system and the thermal losses from the unit.

The gas produced from the gas plasma treatment may, optionally, be treated in a gas cleaning plant. This is preferable since it reduces the potential pollutants that may be produced from the process output. Such plants are well known in the art and serve to remove harmful or undesirable gases or particulates from a gas. Such treatments generally produce a so-called Air Pollution Control (APC) residue which may be treated as a hazardous waste feedstock in the first plasma treatment unit.

As described above, the feedstock may be subjected to various types of treatment before the gasification or microbial digestion step (‘previous steps’). Preferably, the previous steps include any or all of the following:

1.Picking

Initial treatment to remove objects which are not readily combustible, such as stone, concrete, metal, old tyres etc. Objects having a size in excess of 100 mm or more may also be removed. The process can be carried out on a stationary surface, such as a picking floor. Alternatively or additionally, the feedstock may be loaded onto a moving surface such as a conveyor and passed through a picking station in which mechanical or manual picking of the material takes place.

2. Shredding

Shredding is a highly preferred step. It is carried out to reduce the average particle size. It can also be used to increase blending of feedstock from different sources. It also makes the treatment process more effective. It is found that, during the shredding process, microbial activity may commence and rapidly raise the temperature passing very quickly through the mesophilic phase into the thermophilic phase.

3. Screening

The feedstock may be mechanically screened to select particles with size in a given range. The given range may be from 10 mm to 50 mm. Material less than 10 mm in size comprises dust, dirt and stones and is rejected. The feedstock may be treated to at least two screening processes in succession, each removing progressively smaller fractions of particles. Material removed in the screening process as being too large may be shredded to reduce its average size. Material which is classified by the screen as being of acceptable size and, where applicable, shredded material can then be fed to the treatment vessel.

Subsequent Treatment

The feedstock may be subjected to a number of steps after the microbial digestion treatment step and before the gasification step. These steps may include any of the following:

1. Grading

The material may be screened to remove particles in excess of a given size. For example, particles in excess of 50 mm may be rejected. They may be subsequently shredded to reduce their size, returned to the aerobic digester or simply rejected.

2.Metal Separation

Relatively small metal particles such as iron or aluminium may have passed through the system. They can be removed, for example by a magnetic or electromagnetic remover in a subsequent step. Metal particles removed from the system may then pass to a suitable recycling process.

3.Drying

Suitably, after treatment in the microbial treatment vessel, the feedstock is subjected to an additional drying step. If the moisture level does not exceed 45% by weight, more preferably does not exceed 35% by weight and most preferably does not exceed 25% by weight, after the microbial treatment, the subsequent drying can be carried out relatively simply. For example, in a first drying stage, a forced draught of air may be provided during or after the unloading phase from the treatment vessel. During this stage, the feedstock treated by the microbial digestion stage will still be at high temperature (for example in the range 50-60° C.) and further moisture can be removed simply by forcing air over it. A further drying step may comprise laying the material out on a drying floor. In this step, feedstock is laid out at a thickness of not more than 20 cm over a relatively large area for a suitable period of time, during which the moisture level drops. The feedstock may be agitated, for example by turning using mechanical or manual apparatus such as a power shovel. The feedstock may be turned at intervals of for example of 2-4 hours preferably around 3 hours. Preferably, during this stage, the moisture level drops to below 25% by weight after which no further biological decomposition occurs. Suitably, the feedstock is left on a drying floor for a period in the range 18-48 hours, preferably 24-36 hours, more preferably around 24 hours. It is also found that further drying may take place during subsequent processing, due to the mechanical input of energy. Waste heat from other process equipment, for example from the gasification and/or the plasma treatment step, may be used to dry the material. Air warmed by the heat generated in the gasification and/or plasma treatment steps may be blown into the microbial feedstock treatment vessel and over or through the feedstock to increase the drying rate of these processes.

Alternatively, the drying apparatus may comprise a rotary flash drier or other drying device.

4.Pelletising

In order to convert the treated feedstock to fuel, the feedstock may be classified according to size and subsequently densified to provide pellets of suitable size for use in the gasification step. During this pelletisation stage, further drying of the feedstock may occur, due to heat generation caused by friction and due to further exposure to air. Preferably, in order for pelletising to proceed well, the moisture level of the treated material is in the range 10-25% by weight.

It has been found that the microbial treatment step can be adapted to provide a fuel for use in the gasification step, referred to as Green Coal, which has a calorific value in the order of 14.5 MJ/kg which is about half that of industrial coal.

By blending different sources of feedstock material, fuel produced by the microbial treatment step at different times or with feedstock from different locations can be relatively homogeneous in terms of:

1.Calorific value. The calorific value may be higher if the contents have been significantly dried and/or the proportion of combustibles relative to the ash co9ntent of the fuel has increased.

2.Density—suitably in the range 270-350 kg/m³ more preferably around 300 kg/m³.

3.Moisture level—below 30% by weight and preferably around 20% by weight.

The process of the present invention may comprise a pyrolysis step prior to the gasification step, and after the microbial digestion step, if used. The feedstock that results from the microbial digestion step may be used to supply a feed to a pyrolysis process, as described below.

The apparatus of the present invention may include means for feeding microbially treated feedstock from the treatment vessel to a means for pyrolysing the treated feedstock (i.e. a pyrolysis unit).

If the process involves a pyrolysis step prior to the gasification step, preferably the pyrolysed feedstock is fed to the gasification unit, where the gasification takes place. This will normally require the pyrolysed material to be at a high temperature and the gasification process preferably occurs directly after the pyrolysis process.

As the microbial digestion step is typically carried out in a semi batch-wise fashion, whereas the pyrolysis and gasification processes typically require a continuous feed of material, an interim storage means, for example in the form of a feed hopper may be provided. It is preferred that there is a first delivery means for receiving treated feedstock from the microbial treatment process and feeding it into the interim storage means and a second feed apparatus for feeding the stored treated feedstock from the interim storage means to the pyrolysis apparatus or the gasification apparatus. The second feed means is preferably operated substantially continuously. The first and second feed apparatus may comprise any suitable means, for example conveyor belts or screw feeders.

The invention will now be discussed further with reference to the Figures, provided purely by way of example, in which:

FIG. 1 shows a combined flow chart of the methods of the present invention.

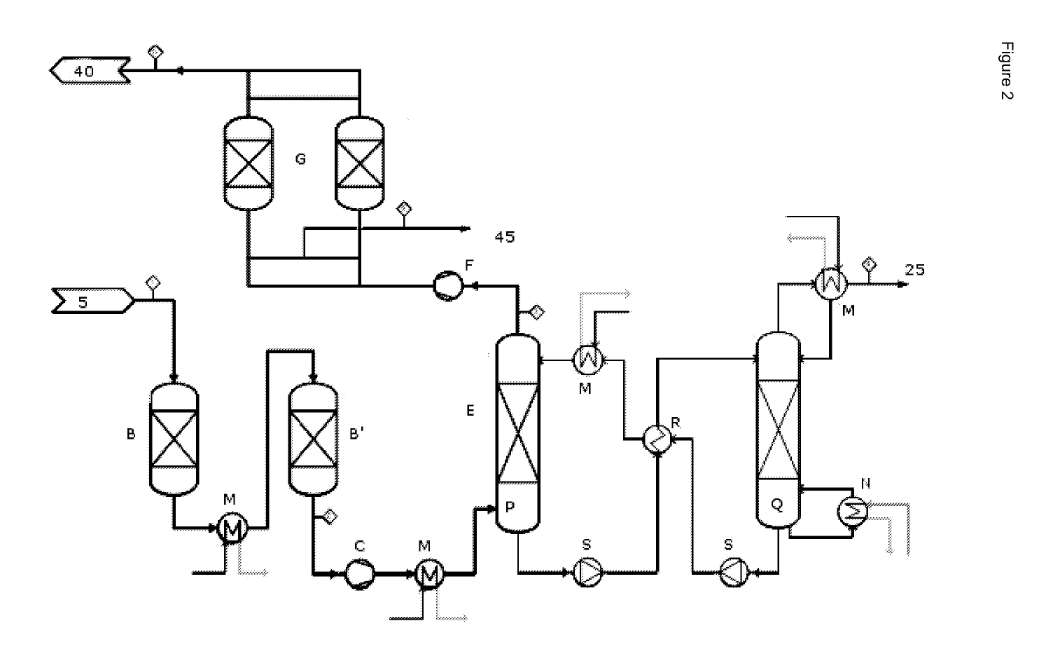

FIG. 2 shows a process flow diagram for the syngas off-gas off treatment downstream of the thermal treatment process.

The process schematic shown in FIG. 1 shows a non-limiting example of the treatment of a feedstock (refuse derived fuel 1) to produce a hydrogen rich gas 40 (99 v % pure) and a carbon dioxide rich gas 25 (99% pure). The RDF 1 is subjected to a gasification and plasma treatment process. This is carried out in gasification and plasma treatment units A to produce a syngas 5.

The syngas 5 contains approximately 37.6 mol % CO, 38.9 mol % H₂ and 16.7 mol % CO₂. The syngas 5 is cooled to a temperature of approximately 60° C. and fed at a pressure of 1 atm to a water gas shift reactor B. In the water gas shift reactor B the syngas 5 is contacted with steam 10. This produces an elevated temperature process gas 15. The process gas 15 has a temperature of 200° C. (1 atm) and comprises approximately 1.4 mol % CO, 55.5 mol % H₂ and 39.1 mol % CO₂. The process gas 15 is passed through a compressor C and a heat-exchanger D to provide the gas with a temperature of approximately 40° C. and a pressure of greater than 5 atm.

The high pressure process gas is then subjected to an amine process in an amine treatment unit E. This allows for the separation of the CO₂ rich gas 25. The remaining process gas 30 comprises approximately 90 mol % H₂ and 1.2 mol % CO₂ and has a temperature of approximately 95° C. and a pressure of approximately 1.5 atm.

This remaining process gas 30 is passed to a further compressor F to provide a compressed gas 35 with a pressure of approximately 14 to 20 atm. This compressed gas 35 is passed to a pressure-swing absorbance unit G to obtain the hydrogen rich gas 40 and a tail gas 45.

Additional detail on a preferred apparatus is provided in FIG. 2, which uses the same numbering. In addition, the following references are used. B is a high temperature water gas shift reactor and B′ is a low temperature water gas shift reactor. M are heat exchangers used to cool the process gas/syngas. P is an amine contactor unit and forms part of the Amine process unit E together with the amine stripper Q. R is a liquid/liquid heat exchanger and forms part of a conventional amine treatment unit. S are centrifugal pumps. N is a reboiler used to heat the amine stripper.

The invention will now be described in relation to the following non-limiting example.

### EXAMPLE 1

The process work-up is based on the standard 150 ktpa MSW/C&I waste throughput, treating 90 ktpa of solids refined fuel in the thermal plant.

A process flow diagram for the syngas off-gas off treatment downstream of the thermal treatment process is given in FIG. 2. The hydrogen and carbon dioxide production and separation plant comprises the following stages:

Water gas shift reactors: The water-gas shift (WGS) reactors are used for further enhancing the yield of hydrogen as well as reducing the CO concentration in syngas. Steam is added to the syngas mixtures, containing mostly hydrogen and carbon monoxide, prior to being sequentially introduced to the high and low temperature WGS reactors to reduce the carbon monoxide concentration to around 0.5% and generate additional hydrogen and carbon dioxide at an overall yield of 98%.

Carbon dioxide purification and separation: An amine separation process is employed for removal of the CO₂. An alkanolamine solvent will be used for chemically absorbing the CO₂ from the gas mixture at high pressure (40 Bar) and low temperature (35-50° C.) in the first contactor stage and the reaction is subsequently reversed in the stripping stage which operates at low pressure (1-2 Bar) and elevated temperature (90-120° C.). The amount of CO₂ recovered in the amine process will be 115,300 tpa at a yield of 98% and a purity of >99%.

Hydrogen purification: A pressure swing absorption process operates at an inlet pressure of 20-30 Bar and a tail gas pressure of ˜1 Bar to separate the hydrogen from the residual gases to give a H₂ product of 99.99% purity, with an overall recovery of 6850 tpa (90% yield). The tail gas is a medium CV gas (containing ˜45% hydrogen and ˜6.0% residual hydrocarbons) and can either be recycled back to the thermal gas plasma unit or else used for heating applications elsewhere on the plant.

The hydrogen fuel was stored and subsequently used in a hydrogen fuel cell to generate electricity. The carbon dioxide gas was compressed to a supercritical form and passed into a mostly depleted oil well. The pressure caused fracturing of the shale within the well and displaced oil and gas were recovered. The displaced oil and gas were reprocessed to recover the carbon dioxide component which was reintroduced and partially sequestered within the oil well.

A study was carried out into the benefits of plasma treatment of a syngas before WGS treatment. An analysis was conducted of tars and condensable hydrocarbon species (ie benzene, toluene, phenol, naphthalene and hexane) contained in a syngas that was generated using a two stage thermal treatment process; gasification, then plasma treatment, as described herein. The measurement of these species was obtained using a Fourier transform infrared (FTIR) instrument. Gas samples were taken pre and post plasma treatment and it was shown that the raw syngas exiting the first stage gasifier contained very elevated levels of these condensable hydrocarbon species. In contrast, these species were observed to have been reduced to very low levels after treatment in the plasma treatment unit.

| Species | Pre-plasma treatment | Post-plasma treatment |
|---|---|---|
| Benzene | <160,000 ppmv | ~50 ppmv |
| Toluene | <170,000 ppmv | ~0 ppmv |
| Phenol | <1,000 ppmv | ~5 ppmv |
| Naphthalene | <29,000 ppmv | <1 ppmv |
| Hexane | <10,000 ppmv | ~0 ppmv |

As will be appreciated, the present invention provides an advantageous source of both hydrogen and carbon dioxide of very high purity from a feedstock. This high purity is obtained cheaply and efficiently due to the benefits of plasma refining of a syngas. The high purity means that the products are suitable for direct use in a number of very important systems such as enhanced oil recovery and electric fuel cells. For the greatest efficiency, it will be appreciated that both the hydrogen and carbon dioxide streams are captured and retained/used.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method for the production of carbon dioxide and/or hydrogen gas streams, the method comprising:
(i) thermally treating a feedstock material to produce a syngas comprising carbon monoxide and hydrogen and plasma-treating the syngas in a plasma treatment unit;
(ii) reacting the plasma-treated syngas with water in a further treatment unit, whereby at least some of the carbon monoxide is converted into carbon dioxide; and
(iii) recovering hydrogen and/or, separately, carbon dioxide from the syngas.

2. The method according to claim 1, wherein the feedstock material is thermally treated by gasifying the feedstock material to produce the syngas.

3. The method according to claim 1, wherein the feedstock material is gasified in a separate treatment unit from the plasma treatment unit.

4. The method according to claim 2, wherein the feedstock is gasified in step (i) in the presence of presence of oxygen and steam.

5. The method according to claim 1, wherein in step (ii) the plasma-treated syngas is reacted with water in the form of steam.

6. The method according to claim 1, wherein:
(a) carbon dioxide is recovered from the syngas by amine separation; and/or
(b) hydrogen is recovered from the syngas by a pressure swing absorption process; and/or
(c) after the hydrogen and/or carbon dioxide is recovered from the syngas, the remaining syngas is passed back into the plasma treatment unit.

7. The method according to claim 1, wherein the feedstock is a waste material, preferably a refuse derived fuel.

8. The method according to claim 1, wherein the plasma treatment is carried out in the presence of water.

9. The method according to claim 1, wherein:
(a) the hydrogen is recovered at a purity of at least 90%; and/or
(b) the carbon dioxide is recovered at a purity of at least 98%.

10. The method according to claim 1, wherein in step (ii) the syngas is contacted with sufficient water to convert substantially all of the carbon monoxide into carbon dioxide and water.

11. The method according to claim 1, wherein after step (ii) water is removed from the syngas by condensation.

12. A method for recovering oil and/or gas from an oil and/or gas well, the method comprising:
performing the steps of claim 1; and
(iv) introducing the recovered carbon dioxide into an oil and/or gas well, whereby oil and/or gas is displaced from the well; and
(v) recovering said oil and/or gas from the well.

13. The method according to claim 12, further comprising recovering heat from the syngas following step(i) to heat the carbon dioxide introduced into the oil and/or gas well.

14. The method according to claim 12, wherein the recovered carbon dioxide is converted into a super critical state before being introduced into the oil and/or gas well.

15. The method of claim 1 comprising said recovering said hydrogen and further comprising passing the recovered hydrogen into a hydrogen fuel cell and contacting said hydrogen with a source of oxygen to generate electricity.

16. An apparatus for carrying out the method of claim 1, the apparatus comprising;
(a) an optional gasification unit for the gasification of a feedstock;
(b) a plasma treatment unit, the plasma treatment unit being in fluid communication with the gasification unit, where present; and
(c) an amine separation unit in fluid communication with said plasma treatment unit.

17. The apparatus according to claim 16, wherein the apparatus comprises the gasification unit and wherein the gasification unit is a fluidised bed gasification unit.

18. The apparatus of claim 16 comprising at least one of:
(i′) an oil and/or gas well and means for introducing carbon dioxide produced by said method into said well; and
(ii′) a hydrogen fuel cell.

19. The method of claim 1 comprising the recovering the carbon dioxide from the syngas and further comprising:
(iv) introducing the recovered carbon dioxide into an oil and/or gas well, whereby oil and/or gas is displaced from the well; and
(v) recovering said oil and/or gas from the well.
